(19) United States
(12) Patent Application Publication
(10) Pub. No.: US 2024/0336507 A1
(43) Pub. Date: Oct. 10, 2024

(54) ENHANCING WATER TREATMENT RECOVERY FROM RETENTION POND AT FERTILIZER PLANTS

(71) Applicant: Evoqua Water Technologies LLC, Pittsburgh, PA (US)

(72) Inventors: Simon P Dukes, Chelmsford, MA (US); Joshua Griffis, Ashburnham, MA (US); Li-Shiang Liang, Harvard, MA (US); Harshita Gogoi, Foster City, CA (US); Wenxin Du, Dover, NH (US); Thomas K Mallmann, Rockford, IL (US)

(73) Assignee: Evoqua Water Technologies LLC, Pittsburgh, PA (US)

(21) Appl. No.: 18/560,118

(22) PCT Filed: May 26, 2022
(86) PCT No.: PCT/US22/31126

§ 371 Date: Nov. 10, 2023

Related U.S. Application Data
(60) Provisional application No. 63/193,787, filed on May 27, 2021.

(51) Int. Cl. C02F 9/00; B01D 61/02; B01D 61/14; B01D 61/16; B01D 61/58; C02F 1/00; C02F 1/44; C02F 1/52; C02F 1/66; C02F 5/00; C02F 101/14; C02F 103/34

(52) U.S. Cl. CPC C02F 9/00; B01D 61/16; B01D 61/58; B01D 61/026; B01D 61/027; B01D 61/029; B01D 61/145; B01D 2311/04; B01D 2311/08; B01D 2317/025; B01D 2317/08; C02F 1/004; C02F 1/441; C02F 1/442; C02F 1/444; C02F 1/5236; C02F 1/66; C02F 5/00; C02F 2101/14; C02F 2103/34; C02F 2301/08

(57) ABSTRACT

A system for the treatment of phosphate-containing wastewater comprises a pretreatment subsystem including a mixing chamber configured to mix a potassium-based salt with the wastewater to precipitate K₂SiF₆ from the wastewater, a solids-liquid separator to separate the precipitated K₂SiF₆ from the wastewater and form a pretreated wastewater, and a mixing chamber to dilute the pretreated wastewater with raw wastewater, and a filtration subsystem including a first filtration configured to receive the pretreated wastewater and remove particles to form a first effluent, a second filtration unit remove divalent ions from the first effluent and form a second effluent, and a third filtration unit configured to remove additional dissolved solids from the second effluent and form a third effluent suitable for discharge to the environment.

### CROSS-REFERENCE TO RELATED APPLICATIONS

This application claims priority under 35 U.S.C. § 119 (e) to U.S. Provisional Application Ser. No. 63/193,787 titled “Enhancing Water Treatment Recovery from Retention Pond at Fertilizer Plants,” filed on May 27, 2021, the entire content of which is incorporated herein by reference in its entirety for all purposes.

### FIELD OF TECHNOLOGY

Aspects and embodiments disclosed herein relate to devices and methods for treating process water to remove toxic and/or harmful components.

### SUMMARY

In accordance with an aspect, there is provided a system for the treatment of wastewater. The system comprises a pretreatment subsystem including a source of a potassium-based salt, a mixing chamber configured to mix the potassium-based salt with the wastewater in an amount sufficient to precipitate a desired amount of potassium hexafluorosilicate (K₂SiF₆) from the wastewater and produce a salt-treated wastewater, and a solids-liquid separation apparatus configured to separate the precipitated K₂SiF₆ from the salt-treated wastewater and form a pretreated wastewater. The system further comprises a filtration subsystem downstream of the pretreatment subsystem and including a first filtration unit having an inlet connectable to an outlet of the pretreatment subsystem and configured to receive the pretreated wastewater, the first filtration unit configured to separate the pretreated wastewater into a first effluent stream and a first reject stream, the first effluent stream having a lesser particulate concentration than the pretreated wastewater, a second filtration unit downstream of the first filtration unit and configured to receive the first effluent stream and separate the first effluent stream into a second effluent stream and a second reject stream, the second effluent stream having a lower concentration of multivalent ions than the first effluent stream, and a third filtration unit downstream of the second filtration unit and configured to receive the second effluent stream and filter the second effluent stream to form a third effluent stream having a concentration of dissolved solids lower than a concentration of dissolved solids in the second effluent stream.

In some embodiments, the system further comprises a second mixing chamber configured to dilute the pretreated wastewater with wastewater from a source of the wastewater.

In some embodiments, the system further comprises a bypass line configured to direct the wastewater from the source of wastewater into the second mixing chamber without passing through the pretreatment subsystem.

In some embodiments, the system further comprises a particle filter disposed in fluid communication between the source of wastewater and an inlet of the bypass line.

In some embodiments, the wastewater includes sodium hexafluorosilicate (Na₂SiF₆) and the system further comprises a controller configured to dilute the pretreated wastewater with a volume of the wastewater sufficient to provide the diluted pretreated wastewater with substantially equal saturation levels of K₂SiF₆ and Na₂SiF₆.

In some embodiments, the wastewater includes sodium hexafluorosilicate (Na₂SiF₆) and the system further comprises a controller configured to dilute the pretreated wastewater with a volume of the wastewater sufficient to provide the diluted pretreated wastewater with concentrations of K₂SiF₆ and Na₂SiF₆ having substantially equal potentials for depositing scale in the second filtration unit.

In some embodiments, the system further comprises one or more particle filters fluidically disposed at least one of upstream of the pretreatment subsystem or between the pretreatment subsystem and the filtration subsystem.

In some embodiments, the system further comprises a heater fluidically disposed between the pretreatment subsystem and the filtration subsystem.

In some embodiments, the system further comprises a conduit configured to return the first reject stream to a source of the wastewater.

In some embodiments, the system further comprises a conduit configured to return the second reject stream to a source of the wastewater.

In some embodiments, the system further comprises a source of pH adjustment agent configured to dose the first effluent stream with the pH adjustment agent.

In some embodiments, the system further comprises a source of antiscalant configured to dose the first effluent stream with the antiscalant.

In some embodiments, the third filtration unit includes one or more reverse osmosis units.

In some embodiments, the one or more reverse osmosis units includes a first reverse osmosis unit configured to separate the second effluent stream into a first filtrate stream and a first retentate stream.

In some embodiments, the second filtration unit includes a nanofilter.

In some embodiments, the system further comprises a conduit configured to direct the first retentate stream into an inlet of the nanofilter along with the first effluent stream.

In some embodiments, the one or more reverse osmosis units further includes a second reverse osmosis unit configured to separate the first filtrate stream into a second filtrate stream and a second retentate stream.

In some embodiments, the second filtrate stream is the third effluent stream.

In some embodiments, the system further comprises conduit configured to direct the second retentate stream into an inlet of the first reverse osmosis unit along with the first filtrate stream.

In some embodiments, the first filtration unit includes an ultrafilter.

In accordance with another aspect, there is provided a method for the treatment of wastewater. The method comprises pretreating the wastewater in a pretreatment subsystem including a source of a potassium-based salt, a mixing chamber configured to the potassium-based salt with the wastewater in an amount sufficient to precipitate a desired amount of potassium hexafluorosilicate (K₂SiF₆) from the wastewater and produce a salt-treated wastewater, and a solids-liquid separation apparatus configured to separate the precipitated K₂SiF₆ from the salt-treated wastewater and form a pretreated wastewater. The method further comprises filtering the pretreated wastewater through a filtration subsystem downstream of the pretreatment subsystem and including a first filtration unit having an inlet connectable to an outlet of the pretreatment subsystem and configured to receive the pre-treated wastewater, the first filtration unit configured to separate the pretreated wastewater into a first effluent stream and a first reject stream, the first effluent stream having a lesser particulate concentration than the pretreated wastewater, a second filtration unit downstream of the ultrafilter and configured to receive the first effluent stream and separate the first effluent stream into a second effluent stream and a second reject stream, the second effluent stream having a lower concentration of multivalent ions than the first effluent stream, and a third filtration unit downstream of the nanofilter and configured to receive the second effluent stream and filter the second effluent stream to form a third effluent stream having a concentration of dissolved solids lower than a concentration of dissolved solids in the second effluent stream.

In some embodiments, the method further comprises diluting the pretreated wastewater with wastewater from a source of the wastewater in a second mixing chamber.

In some embodiments, the method further comprises directing the wastewater from the source of wastewater into the second mixing chamber without passing through the pretreatment subsystem.

In some embodiments, the method further comprises filtering the wastewater prior to directing the wastewater into the second mixing chamber.

In some embodiments, the wastewater includes sodium hexafluorosilicate (Na₂SiF₆) and the method further comprises diluting the pretreated wastewater with a volume of the wastewater sufficient to provide the diluted pretreated wastewater with substantially equal saturation levels of K₂SiF₆ and Na₂SiF₆.

In some embodiments, the wastewater includes sodium hexafluorosilicate (Na₂SiF₆) and the method further comprises diluting the pre-treated wastewater with a volume of the wastewater sufficient to provide the diluted pretreated wastewater with concentrations of K₂SiF₆ and Na₂SiF₆ having substantially equal potentials for depositing scale in the second filtration unit.

In some embodiments, the method further comprises one or more of performing particle filtration of the wastewater of upstream of the pretreatment subsystem or performing particle filtration of the pretreated wastewater between the pretreatment subsystem and the filtration subsystem.

In some embodiments, the method further comprises heating the pretreated wastewater in a heater fluidically disposed between the pretreatment subsystem and the filtration subsystem.

In some embodiments, the method further comprises returning the first reject stream to a source of the wastewater.

In some embodiments, the method further comprises returning the second reject stream to a source of the wastewater.

In some embodiments, the method further comprises dosing the first effluent stream with a pH adjustment agent.

In some embodiments, the method further comprises dosing the first effluent stream with an antiscalant.

In some embodiments, the third filtration unit includes one or more reverse osmosis units, and the method further comprises separating the second effluent stream into a first filtrate stream and a first retentate stream with a first reverse osmosis unit of the one or more reverse osmosis units.

In some embodiments, the second filtration unit includes a nanofilter and the method further comprises directing the first retentate stream into an inlet of the nanofilter along with the first effluent stream.

In some embodiments, the method further comprises separating the first filtrate stream into a second filtrate stream and a second retentate stream with a second reverse osmosis unit of the one or more reverse osmosis units.

In some embodiments, the method further comprises providing the second filtrate stream as the third effluent stream.

In some embodiments, the method further comprises directing the second retentate stream into an inlet of the first reverse osmosis unit along with the first filtrate stream.

In some embodiments, the method comprises recovering between 20% and 40% of a volume of the wastewater treated in the system as the third effluent stream.

In some embodiments, the method comprises introducing phosphate-containing wastewater from a phosphogypsum wastewater pond into the pretreatment subsystem as the wastewater.

In some embodiments, the method comprises introducing phosphate-containing wastewater from a phosphogypsum wastewater pond having a pH of about 2 into the pretreatment subsystem as the wastewater.

In accordance with another aspect, there is provided a method for the treatment of wastewater. The method comprises adding a potassium-based salt to the wastewater to cause precipitation of sodium hexafluorosilicate (Na₂SiF₆) from the wastewater, separating precipitated Na₂SiF₆ from the wastewater to form a pretreated wastewater and a Na₂SiF₆ sludge, removing particulate matter from the pretreated wastewater in a first filtration unit to form a first effluent stream and a first reject stream, the first effluent stream having a lesser particulate concentration than the pretreated wastewater, selectively removing divalent ions from the first effluent stream in a second filtration unit to form a second effluent stream and a second reject stream, the second effluent stream having a lower concentration of multivalent ions than the first effluent stream, the second reject stream including phosphates, and removing dissolved solids from the second effluent stream in a third filtration unit to form a third effluent stream and a third reject stream, the third effluent stream having a concentration of dissolved solids lower than a concentration of dissolved solids in the second effluent stream.

In some embodiments, the method further comprises diluting the pretreated water with the wastewater.

In some embodiments, an amount of wastewater used to dilute the salt-treated water is selected to provide the diluted pretreated wastewater with substantially equal saturation levels of K₂SiF₆ and Na₂SiF₆.

In some embodiments, an amount of wastewater used to dilute the salt-treated water is selected to provide the diluted pretreated wastewater with concentrations of K₂SiF₆ and Na₂SiF₆ having substantially equal potentials for depositing scale in the second filtration unit.

In some embodiments, an amount of wastewater used to dilute the salt-treated water is selected to provide the diluted pretreated wastewater with concentrations of K₂SiF₆ and Na₂SiF₆ having substantially equal potentials for depositing scale in the second filtration unit.

In some embodiments, the method further comprises recycling the third reject stream to an inlet of the third filtration unit.

In some embodiments, the method comprises recovering between 20% and 40% of a volume of the wastewater treated in the system as the third effluent stream.

In accordance with another aspect, there is provided a treatment system comprising a pretreatment subsystem including a first stream comprising dissolved potassium species, a mixing chamber configured to mix the first stream with a second stream, the second stream comprising hexafluorosilicate, the mixing chamber comprising an outlet for a third stream, the third stream comprising potassium hexafluorosilicate (K₂SiF₆), and a solids-liquid separator fluidly connected to the outlet of the mixing chamber, the solids-liquid separator configured to separate K₂SiF₆ as a precipitate from the third stream and produce a pretreated stream. The treatment system further comprises a filtration subsystem fluidly connected downstream of the pretreatment subsystem and including a first filtration unit having an inlet fluidly connected to an outlet of the pretreatment subsystem and configured to receive the pretreated stream, the first filtration unit configured to separate the pretreated stream into a first effluent stream and a first reject stream, the first effluent stream having a lesser particulate concentration than the pretreated stream, a second filtration unit downstream of the first filtration unit and configured to receive the first effluent stream and separate the first effluent stream into a second effluent stream and a second reject stream, the second effluent stream having a lower concentration of multivalent ions than the first effluent stream, and a third filtration unit downstream of the second filtration unit and configured to receive the second effluent stream and filter the second effluent stream to form a third effluent stream having a concentration of dissolved solids lower than a concentration of dissolved solids in the second effluent stream.

In some embodiments, the system further comprises a second mixing chamber configured to dilute the pretreated stream with wastewater from a source of wastewater to produce a diluted pretreated stream.

In some embodiments, the system further comprises a particle filter disposed in fluid communication between the source of wastewater and the second mixing chamber.

In some embodiments, the first stream includes sodium hexafluorosilicate (Na₂SiF₆) and the system further comprises a controller configured to regulate dilution of the pretreated stream with the wastewater to render substantially equal saturation levels of Na₂SiF₆ and K₂SiF₆ in the diluted pretreated stream.

In some embodiments, the first stream includes sodium hexafluorosilicate (Na₂SiF₆) and the system further comprises a controller configured to regulate dilution of the pretreated stream with the wastewater to render the diluted pretreated stream with concentrations of K₂SiF₆ and Na₂SiF₆ having substantially equal potentials for depositing scale in the second filtration unit.

In some embodiments, the system further comprises one or more particle filters fluidically disposed at least one of upstream of the pretreatment subsystem or between the pretreatment subsystem and the filtration subsystem.

In some embodiments, the system further comprises a heater fluidly connected between the pretreatment subsystem and the filtration subsystem.

In some embodiments, the system further comprises a conduit configured to return the first reject stream to a source of the first stream.

In some embodiments, the system further comprises a conduit configured to return the second reject stream to a source of the first stream.

In some embodiments, the system further comprises a source of pH adjustment agent configured to dose the first effluent stream with the pH adjustment agent.

In some embodiments, the system further comprises a source of antiscalant configured to dose the first effluent stream with the antiscalant.

In some embodiments, the third filtration unit includes one or more reverse osmosis units.

In some embodiments, the one or more reverse osmosis units includes a first reverse osmosis unit configured to separate the second effluent stream into a first permeate stream and a first retentate stream.

In some embodiments, the second filtration unit includes a nanofilter.

In some embodiments, the system further comprises a conduit configured to direct the first retentate stream into an inlet of the nanofilter or to a source of the first stream.

In some embodiments, the one or more reverse osmosis units further includes a second reverse osmosis unit configured to separate the first permeate stream into a second permeate stream and a second retentate stream.

In some embodiments, the second permeate stream is the third effluent stream.

In some embodiments, the system further comprises a conduit configured to direct the second retentate stream into an inlet of the first reverse osmosis unit along with the first permeate stream.

In some embodiments, the first filtration unit includes an ultrafilter.

In accordance with another aspect, there is provided a method for the treatment of wastewater. The method comprises treating the wastewater in any embodiments of the system described above.

In some embodiments, the method comprises recovering between 20% and 40% of a volume of the wastewater treated in the system as the third effluent stream.

In some embodiments, the first stream comprises phosphate-containing wastewater from a phosphogypsum wastewater pond.

In accordance with another aspect, there is provided a method for the treatment of wastewater. The method comprises adding dissolved ionic potassium to the wastewater to promote precipitation of sodium hexafluorosilicate (Na₂SiF₆) from the wastewater, separating precipitated Na₂SiF₆ from the wastewater to form a pretreated wastewater and a Na₂SiF₆ sludge, removing particulate matter from the pretreated wastewater in a first filtration unit to form a first effluent stream and a first reject stream, the first effluent stream having a lesser particulate concentration than the pretreated wastewater, selectively removing divalent ions from the first effluent stream in a second filtration unit to form a second effluent stream and a second reject stream, the second effluent stream having a lower concentration of multivalent ions than the first effluent stream, the second reject stream including phosphates, and removing dissolved solids from the second effluent stream in a third filtration unit to form a third effluent stream and a third reject stream, the third effluent stream having a concentration of dissolved solids lower than a concentration of dissolved solids in the second effluent stream.

In some embodiments, the method further comprises diluting the pretreated water with the wastewater.

In some embodiments, an amount of wastewater used to dilute the salt-treated water is selected to provide the diluted pretreated wastewater with substantially equal saturation levels of K₂SiF₆ and Na₂SiF₆.

In some embodiments, an amount of wastewater used to dilute the salt-treated water is selected to provide the diluted pretreated wastewater with concentrations of K₂SiF₆ and Na₂SiF₆ having substantially equal potentials for depositing scale in the second filtration unit.

In some embodiments, an amount of wastewater used to dilute the salt-treated water is selected to provide the diluted pretreated wastewater with concentrations of K₂SiF₆ and Na₂SiF₆ having substantially equal potentials for depositing scale in the second filtration unit.

In some embodiments, the method further comprises recycling the third reject stream to an inlet of the third filtration unit.

In some embodiments, the method comprises recovering between 20% and 40% of a volume of the wastewater treated in the system as the third effluent stream.

In accordance with another aspect, there is provided a method of treating water to be treated having sodium hexafluorosilicate and phosphate. The method comprises adding ionic potassium to a first portion of water to be treated to promote formation of potassium hexafluorosilicate precipitate, removing at least a portion of the potassium hexafluorosilicate precipitate to produce a first supernatant, mixing the first supernatant with a second portion of the water to be treated, the relative amounts of the first portion and the second portion being in a range of from about 1:10 to 1:5, and introducing at least a portion of the supernatant to a first reverse osmosis unit to produce a first permeate and a first retentate.

In some embodiments, the method further comprises introducing the first permeate to a second reverse osmosis unit to produce a second permeate and a second retentate, and introducing the second retentate, with the at least a portion of the supernatant, into the first reverse osmosis unit.

In some embodiments, adding the ionic potassium comprises regulation of addition of the ionic potassium sufficient to create a dosage of K⁺ in a range of from about 0.07 mg/L to about 0.2 mg/L in the first portion of the water to be treated.

In some embodiments, the method further comprises filtering the at least a portion of the supernatant prior to introducing the at least a portion of the supernatant into the first reverse osmosis unit to produce a first reject, and directing the first reject to the source of the water to be treated.

In some embodiments, the method further comprises, prior introducing the at least a portion of the supernatant into the first reverse osmosis unit, adjusting a pH of the at least a portion of the supernatant to be about 2, and prior to introducing the at least a portion of the supernatant into the first reverse osmosis unit, adding an antiscalant to the at least a portion of the supernatant.

In accordance with another aspect, there is provided a water treatment system. The system comprises a pretreatment subsystem including a first stream comprising dissolved potassium species, a mixing chamber configured to mix the first stream with a second stream, the second stream comprising hexafluorosilicate, the mixing chamber comprising an outlet for a third stream, the third stream comprising potassium hexafluorosilicate (K₂SiF₆), and a solids-liquid separator fluidly connected to the outlet of the mixing chamber, the solids-liquid separator configured to separate K₂SiF₆ as a precipitate from the third stream and produce a pretreated stream, and a filtration subsystem fluidly connected downstream of the pretreatment subsystem.

In some embodiments, the filtration subsystem comprises a first filtration unit having an inlet fluidly connected to an outlet of the pretreatment subsystem and configured to receive the pretreated stream, the first filtration unit configured to separate the pretreated stream into a first effluent stream and a first reject stream, the first effluent stream having a lesser particulate concentration than the pretreated stream, a second filtration unit downstream of the first filtration unit and configured to receive the first effluent stream and separate the first effluent stream into a second effluent stream and a second reject stream, the second effluent stream having a lower concentration of multivalent ions than the first effluent stream, and a third filtration unit downstream of the second filtration unit and configured to receive the second effluent stream and filter the second effluent stream to form a third effluent stream having a concentration of dissolved solids lower than a concentration of dissolved solids in the second effluent stream.

In some embodiments, the system further comprises a conduit configured to return the first reject stream to a source of the first stream.

In some embodiments, the system further comprises a conduit configured to return the second reject stream to a source of the first stream.

In some embodiments, the system further comprises a source of pH adjustment agent configured to dose the first effluent stream with the pH adjustment agent.

In some embodiments, the system further comprises a source of antiscalant configured to dose the first effluent stream with the antiscalant.

In some embodiments, the third filtration unit includes one or more reverse osmosis units.

In some embodiments, the one or more reverse osmosis units includes a first reverse osmosis unit configured to separate the second effluent stream into a first permeate stream and a first retentate stream.

In some embodiments, the second filtration unit includes a nanofilter.

In some embodiments, the system further comprises a conduit configured to direct the first retentate stream into an inlet of the nanofilter or to a source of the first stream.

In some embodiments, the one or more reverse osmosis units further includes a second reverse osmosis unit configured to separate the first permeate stream into a second permeate stream and a second retentate stream.

In some embodiments, the second permeate stream is the third effluent stream.

In some embodiments, the system further comprises a conduit configured to direct the second retentate stream into an inlet of the first reverse osmosis unit along with the first permeate stream.

In some embodiments, the first filtration unit includes an ultrafilter.

In some embodiments, the first stream comprises KCl at a concentration in a range of from 0.07 mol/L to 0.2 mol/L.

In some embodiments, the system further comprises a second mixing chamber configured to dilute the pretreated stream with wastewater from a source of wastewater to produce a diluted pretreated stream.

In some embodiments, the system further comprises a particle filter disposed in fluid communication between the source of wastewater and an inlet of the second mixing chamber.

In some embodiments, the first stream includes sodium hexafluorosilicate (Na₂SiF₆) and the system further comprises a controller configured to regulate dilution of the pretreated stream with the wastewater to render substantially equal saturation levels of Na₂SiF₆ and K₂SiF₆ in the diluted pretreated stream.

In some embodiments, the first stream includes sodium hexafluorosilicate (Na₂SiF₆) and the system further comprises a controller configured to regulate dilution of the pretreated stream with the wastewater to render the diluted pretreated stream with concentrations of K₂SiF₆ and Na₂SiF₆ having substantially equal potentials for depositing scale in the second filtration unit.

In some embodiments, the system further comprises one or more particle filters fluidically disposed at least one of upstream of the pretreatment subsystem or between the pretreatment subsystem and the filtration subsystem.

In some embodiments, the system further comprises a heater fluidly connected between the pretreatment subsystem and the filtration subsystem.

In accordance with another aspect, there is provided a method for the treatment of wastewater, the method comprising treating the wastewater in any examples of the system described above.

In some embodiments, the method comprises recovering between 20% and 40% of a volume of the wastewater treated in the system as the third effluent stream.

In some embodiments, the first stream comprises phosphate-containing wastewater from a phosphogypsum wastewater pond.

In accordance with another aspect, there is provided a method for the treatment of wastewater. The method comprises adding dissolved ionic potassium to the wastewater to promote precipitation of sodium hexafluorosilicate (Na₂SiF₆) from the wastewater, separating precipitated Na₂SiF₆ from the wastewater to form a pretreated wastewater and a Na₂SiF₆ sludge, removing particulate matter from the pretreated wastewater in a first filtration unit to form a first effluent stream and a first reject stream, the first effluent stream having a lesser particulate concentration than the pretreated wastewater, selectively removing divalent ions from the first effluent stream in a second filtration unit to form a second effluent stream and a second reject stream, the second effluent stream having a lower concentration of multivalent ions than the first effluent stream, the second reject stream including phosphates, and removing dissolved solids from the second effluent stream in a third filtration unit to form a third effluent stream and a third reject stream, the third effluent stream having a concentration of dissolved solids lower than a concentration of dissolved solids in the second effluent stream.

In some embodiments, the method further comprises diluting the pretreated water with the wastewater.

In some embodiments, an amount of wastewater used to dilute the salt-treated water is selected to provide the diluted pretreated wastewater with substantially equal saturation levels of K₂SiF₆ and Na₂SiF₆.

In some embodiments, an amount of wastewater used to dilute the salt-treated water is selected to provide the diluted pretreated wastewater with concentrations of K₂SiF₆ and Na₂SiF₆ having substantially equal potentials for depositing scale in the second filtration unit.

In some embodiments, an amount of wastewater used to dilute the salt-treated water is selected to provide the diluted pretreated wastewater with concentrations of K₂SiF₆ and Na₂SiF₆ having substantially equal potentials for depositing scale in the second filtration unit.

In some embodiments, the method further comprises recycling the third reject stream to an inlet of the third filtration unit.

In some embodiments, the method comprises recovering between 20% and 40% of a volume of the wastewater treated in the system as the third effluent stream.

In accordance with another aspect, there is provided a method of treating water to be treated having sodium hexafluorosilicate and phosphate. The method comprises adding ionic potassium to a first portion of water to be treated to promote formation of potassium hexafluorosilicate precipitate, removing at least a portion of the potassium hexafluorosilicate precipitate to produce a first supernatant, mixing the first supernatant with a second portion of the water to be treated, the relative amounts of the first portion and the second portion being in a range of from about 1:10 to 1:5, and introducing at least a portion of the supernatant to a first reverse osmosis unit to produce a first permeate and a first retentate.

In some embodiments, the method further comprises introducing the first permeate to a second reverse osmosis unit to produce a second permeate and a second retentate, and introducing the second retentate, with the at least a portion of the supernatant, to the first reverse osmosis unit.

In some embodiments, adding the ionic potassium comprises regulation of addition of the ionic potassium sufficient to create a dosage of K⁺ in a range of from about 0.07 mg/L to about 0.2 mg/L in the first portion of the water to be treated.

In some embodiments, the method further comprises filtering the at least a portion of the supernatant prior to introducing the at least a portion of the supernatant into the first reverse osmosis unit to produce a first reject, and directing the first reject to the source of the water to be treated.

In some embodiments, the method further comprises prior introducing the at least a portion of the supernatant into the first reverse osmosis unit, adjusting a pH of the at least a portion of the supernatant to be about 2, and prior to introducing the at least a portion of the supernatant into the first reverse osmosis unit, adding an antiscalant to the at least a portion of the supernatant.

### BRIEF DESCRIPTION OF THE DRAWINGS

The accompanying drawings are not drawn to scale. In the drawings, each identical or nearly identical component that is illustrated in the various figures is represented by a like numeral. For purposes of clarity, not every component may be labeled in every drawing. In the drawings:

FIG. 1 illustrates one example of a system for treating process water;

FIG. 2 illustrates another example of a system for treating process water:

FIG. 3 illustrates results of a simulation of saturation levels of sodium hexafluorosilicate and potassium hexafluorosilicate in diluted pretreated wastewater produced in an example of a process disclosed herein:

FIG. 4 is a flowchart of a method of treating process water utilizing a system as disclosed herein:

FIG. 5 illustrates results of testing of precipitation of SiF₆ from synthetic wastewater by addition of KCl; and

FIG. 6 illustrates results of calculations of scaling potential of KCl-treated synthetic wastewater as a function of amount of raw synthetic wastewater blended with the KCl-treated synthetic wastewater.

### DETAILED DESCRIPTION

Phosphate-containing wastewater, for example, wastewater associated with and produced by phosphate manufacturing operations, referred to herein as “process water,” is typically acidic and typically contains various dissolved constituents such as fluoride, ammonia, silica, sulfate, calcium, heavy metals, phosphate, magnesium, colloidal matter, organic carbon, and in some instances radium (a radioactive element). Ponds associated with past phosphate processing may contain billions of gallons of process water. There is an urgent environmental need to treat this process water, particularly in environmentally sensitive areas, or areas where population growth has come into closer contact with phosphate processing sites. Treatment of process water to reduce its toxicity and its volume has been a technological challenge of significant interest. The toxic or harmful contaminants present in process water should be at least partially removed or eliminated before treated process water is discharged into the environment to comply with regulatory guidelines and to protect the environment.

Various techniques have been used to reduce the level of toxic or harmful contaminants in process water before the treated process water is discharged to the environment. For example, double liming, followed by air stripping can be used. In this process lime is added to the process water in two stages, to promote precipitation of fluoride species and phosphate species, followed by high pH air stripping to remove ammonia. In another technique, process water is treated by chemical precipitation followed by reverse osmosis. Like double liming, such techniques raise the pH of influent water to promote precipitation and solids separation before reverse osmosis.

Another process that may be used to dispose of process water is deep well injection. This process injects the process water deep underground between impermeable layers of rocks to avoid polluting fresh water supplies. Proper geology is required for deep well injection sites, and a permit must be obtained prior to injecting the process water underground. Further, phosphate is not recoverable from process water in a deep well injection process.

Another process that could be used to treat process water is reverse osmosis. Reverse osmosis treats water having a low pH to remove contaminants by using one or more passes of reverse osmosis membranes with or without controlling the pH between passes.

Although the above referenced techniques may be used to treat process water, they are expensive and not effective at recovering concentrated phosphoric acid, which is a valuable product, from the process water.

In phosphoric acid production, phosphate ore mined from the ground is reacted with concentrated sulfuric acid. This process produces phosphogypsum sludge, phosphoric acid for use in fertilizer production, and a byproduct liquid stream. The byproduct stream may be reused for cooling but ultimately is typically stored in large open-air enclosures called phosphogypsum stacks.

The stacks can store up to 3 billion gallons of phosphogypsum wastewater, with around three percent phosphoric acid. Due to increasingly strict environmental regulations and annual rainfall, the stacks must be treated and closed by the operating company, sometime after acid plant shutdown. Due to the chemical complexity and volume of the wastewater, the relatively simple and inexpensive double line treatment (DLT) method has been widely employed to closing phosphogypsum stacks for years. The DLT supernatant is diluted up to 5-10 times to meet National Pollutant Discharge Elimination System (NPDES) discharge requirements (specifically Florida's state-wide conductivity limit of 1,275 μS/cm).

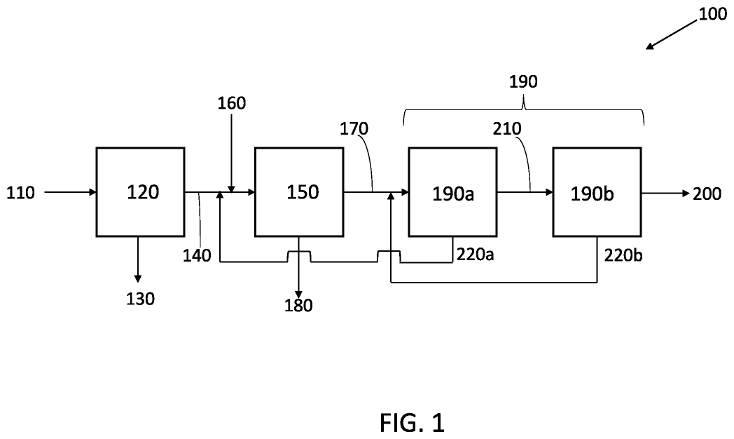

One example of a system and method for treating the pond water from a phosphogypsum wastewater pond is illustrated generally at 100 in FIG. 1. In the system 100, phosphate-containing wastewater 110, also referred to herein as “feed,” “wastewater,” or “pond water” from a phosphogypsum wastewater pond is treated with a series of pressure-driven membrane units. The wastewater 110 is first treated in a first pressure-driven filtration unit 120 to remove particles from the wastewater 100. The first filtration unit 120 may be, for example, an ultrafiltration unit having a membrane with an effective pore size of approximately 0.002 to 0.1 microns and a molecular weight cut-off (MWCO) of approximately 10,000 to 100,000 Daltons. The first pressure-driven filtration unit 120 may operate with a recovery (the amount of filtrate as a fraction of the amount of feed introduced into the filtration unit) of about 70%, depending on the level of suspended solids in the wastewater 110. The filtrate or effluent 140 from the first filtration unit 120 (the “first effluent stream”) is directed into a second pressure-driven filtration unit 150, while the reject or retentate stream 130 (the “first reject stream”) from the first filtration unit 120 is returned to the wastewater pond. Antiscalant from a source of antiscalant 160 may be mixed into the effluent 140 from the first filtration unit 120 prior to the effluent 140 being introduced into the second filtration unit 150.

The second filtration unit 150 is configured to selectively remove multivalent ions from the effluent 140 from the first filtration unit 120 and separate the first effluent stream 140 into a second effluent stream 170 with a lower ionic content than the first effluent stream 140 and a second reject stream 180 having a higher ionic content than the first effluent stream 140. The second filtration unit 150 may be, for example, a nanofiltration unit having a membrane with an effective pore size of approximately 0.001 microns and a MWCO of approximately 1,000 to 100,000 Daltons. The second reject stream 180 may also be returned to the wastewater pond while the second effluent stream 170 is sent to a third pressure-driven filtration unit 190.

The third filtration unit 190 is configured to remove sufficient remaining ionic contaminants from the second effluent stream 170 to produce a third effluent stream 200 that meets regulations for discharge to the environment, for example, having a conductivity of less than 1,275 μS/cm as discussed above. The third filtration unit may be a dual stage reverse osmosis treatment unit having an upstream reverse osmosis unit 190a and a downstream reverse osmosis unit 190b each having an effective pore size of about 0.001 microns or less and a MWCO of 100 Daltons or less. The upstream reverse osmosis unit 190a receives the second effluent stream 170 from the second filtration unit and separates it into an intermediate effluent stream 210 that is directed to the downstream reverse osmosis unit 190b and a first reverse osmosis reject stream 220a. The downstream reverse osmosis unit 190b separates the intermediate effluent stream 210 into the third effluent stream 200 and a second reverse osmosis reject stream 210b. The first reverse osmosis reject stream 210a may be recycled and mixed with the first effluent stream 140 for introduction into the second filtration unit 150. The second reverse osmosis reject stream 210b may be recycled and mixed with the second effluent stream 170 for introduction into the upstream reverse osmosis unit 190a.

A limiting step for a system such as system 100 is the nanofiltration process where the water recovery may reach only about 20% due to deposition of scale on the nanofiltration membrane by precipitation of sodium hexafluorosilicate (Na₂SiF₆) from the first effluent stream. The low nanofiltration unit recovery ultimately leads to about 10% overall system recovery.

To address the low recovery of a system such as system 100 an upfront chemical pretreatment subsystem may be added to pretreat the phosphogypsum wastewater 110 so that the recovery in the nanofiltration process can be effectively increased. Specifically, a potassium-based salt (for example, KCl, KNO₃, K₂SO₄, KHCO₃, or K₂CO₃) is mixed with incoming phosphogypsum wastewater 110 to cause hexafluorosilicate (SiF₆²⁻) to precipitate out in the form of potassium hexafluorosilicate (K₂SiF₆). In some embodiments, the incoming phosphogypsum wastewater 110 is dosed with KCl at a concentration in a range of from 0.07 mol/L to 0.2 mol/L. It is possible to add an appropriate amount of KHCO₃ or K₂CO₃ or any combination of potassium-based salts to reduce the tendency of potential corrosion introduced by chloride. The solubility of K₂SiF₆ in water at 20° C. is 0.0055 mol/L or 1.21 g/L which is a few times smaller than that of Na₂SiF₆ (0.036 mol/L or 6.77 g/L). The solubilities of K₂SiF₆ and Na₂SiF₆ in a phosphogypsum wastewater pond environment may be higher, for example, around 3.63 and 12.67 g/L, respectively.

Simulations were performed that suggest that by adding potassium-based salt, as much as about 76% of the SiF₆²⁻ may be removed from the phosphogypsum wastewater and the phosphogypsum wastewater will be saturated with K₂SiF₆. To facilitate further processing through pressure driven membrane processes such as described above with reference to system 100, the saturation level of K₂SiF₆ in the potassium salt-treated phosphogypsum wastewater may be reduced. This can be achieved by blending the potassium salt-treated phosphogypsum wastewater with the untreated phosphogypsum wastewater (bypassed pond water) at appropriate ratios. Table 1 and Table 2 below list typical concentrations of SiF₆²⁻, Na⁺, and K⁺, along with the projected saturation levels of K₂SiF₆ and Na₂SiF₆ at varied blend ratios.

TABLE 1

| % Potassium | | | | | Ksp, K2SiF6, | K2SiF6 |
|---|---|---|---|---|---|---|
| salt treated | % Pond water | | | | projected in | Saturation |
| water | bypassed | SiF6, mol/L | K+, mol/L | [K+]\hat{ }2*[SiF6] | pond water | level |
| 100 | 0 | 1.651E−02 | 3.302E−02 | 1.800E−05 | 1.800E−05 | 100% |
| 50 | 50 | 4.210E−02 | 2.093E−02 | 1.844E−05 | | 102% |
| 33 | 67 | 5.064E−02 | 1.690E−02 | 1.446E−05 | | 80% |
| 25 | 75 | 5.490E−02 | 1.488E−02 | 1.216E−05 | | 68% |
| 20 | 80 | 5.746E−02 | 1.368E−02 | 1.075E−05 | | 60% |
| 0 | 100 | 6.770E−02 | 8.840E−03 | 5.290E−06 | | 29% |

TABLE 2

| % Potassium | | | | | Ksp, Na2SiF6, | Na2SiF6 |
|---|---|---|---|---|---|---|
| salt treated | % Pond water | | | | projected at | Saturation |
| water | bypassed | SiF6, mol/L | Na+, mol/L | [Na+]\hat{ }2*[SiF6] | 100° F. | level |
| 100 | 0 | 1.651E−02 | 1.420E−01 | 3.329E−04 | 1.380E−03 | 24% |
| 50 | 50 | 3.866E−02 | 1.420E−01 | 7.796E−04 | | 56% |
| 33 | 67 | 4.650E−02 | 1.420E−01 | 9.376E−04 | | 68% |
| 25 | 75 | 5.042E−02 | 1.420E−01 | 1.017E−03 | | 74% |
| 20 | 80 | 5.277E−02 | 1.420E−01 | 1.064E−03 | | 77% |
| 0 | 100 | 6.217E−02 | 1.420E−01 | 1.254E−03 | | 91% |

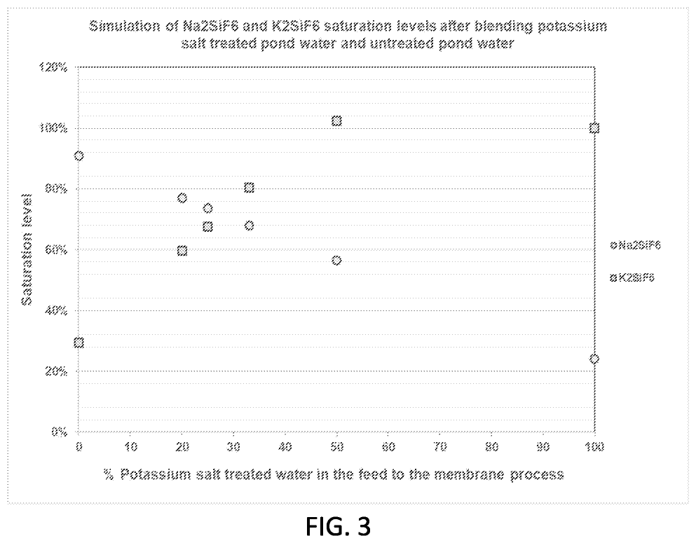

These simulated results are only proximate because (1) the solubility constant (Ksp) values for K₂SiF₆ and Na₂SiF₆ are estimated since they are temperature and environment dependent; (2) for simplification, all activity coefficients are deemed as unity. Table 2 indicates the saturation level of Na₂SiF₆ in typical phosphogypsum wastewater pond water is 91%. In some embodiments it may be desirable to add an amount of potassium-based salt to the phosphogypsum wastewater to be treated and then blend a sufficient amount of untreated phosphogypsum wastewater with the salt-treated wastewater so that the saturation levels of K₂SiF₆ and Na₂SiF₆ in the blend are approximately equal. Each of the of K₂SiF₆ and Na₂SiF₆ would thus be equally far from saturation that the potential for either to precipitate as scale in a nanofilter may be minimized. As seen from FIG. 3, the operating condition at which the saturation levels of K₂SiF₆ and Na₂SiF₆ in the blend are approximately equal is around 25% potassium salt-treated wastewater to 75% untreated wastewater, where the saturation level lines of K₂SiF₆ and Na₂SiF₆ lines across each other. Under this condition, the saturation level of K₂SiF₆ and Na₂SiF₆ are projected as 68% and 74%, respectively. As such, it is estimated that the water recovery of nanofilter may possibly be increased to 30% as compared to 20% without the potassium salt pretreatment and the overall system recovery increased to about 20% (a 100% improvement).

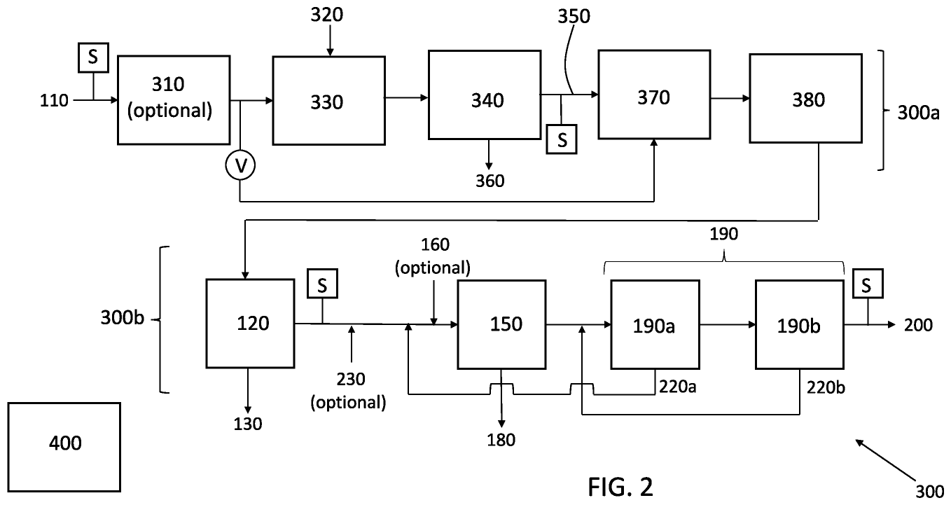

One example of a system 300 for treating phosphogypsum wastewater with an improved recovery as compared to the system 100 discussed above is illustrated generally at 300 in FIG. 2. The system 300 includes a pretreatment subsystem 300a and a filtration subsystem 300b. The filtration subsystem 300b is similar to system 100 described above, although the antiscalant 160 may be rendered optional or even unneeded by the addition of the pretreatment subsystem 300a. Further, a caustic or acid, for example, NaOH, HCL, H₂SO₄ or another suitable caustic, acid or other pH adjustment agent from a source of pH adjustment agent 230 may be added to the first effluent from the first filtration unit 120 adjust the pH of the first effluent to, for example, about 2 or to provide the third effluent 200 with a more neutral pH.

The pretreatment subsystem 300a receives the raw phosphogypsum wastewater 110 from the phosphogypsum wastewater pond and optionally performs a first coarse filtration operation in a prefilter 310, for example, a screen filter or sand filter. A quantity of potassium-based salt from a source 320 of the salt is added to and mixed with the optionally prefiltered phosphogypsum wastewater 110. The quantity of potassium-based salt added to and mixed with the optionally prefiltered phosphogypsum wastewater 110 may be determined by factors such as contaminant levels in the phosphogypsum wastewater 110, pH, temperature, flow rate, or any other property of the phosphogypsum wastewater 110 or a target purity of the final third effluent 200. The potassium-based salt may be added to and mixed with the optionally prefiltered phosphogypsum wastewater 110 in a mixing chamber 330 which may be a vessel including mixing blades, aerators, or other mechanical features to facilitate mixing of the potassium-based salt and optionally prefiltered phosphogypsum wastewater 110. Alternatively, the mixing chamber 330 may be a section of conduit through which the optionally prefiltered phosphogypsum wastewater 110 flows and to which the potassium-based salt is added. The section of conduit forming the mixing chamber 330 may include a static mixer, for example, a plate-type static mixer, a helical static mixer, or other form of static mixer that induces turbulence in the phosphogypsum wastewater 110 passing through it.

Once the potassium-based salt is added to the phosphogypsum wastewater 110 K₂SiF₆ may begin to precipitate from the phosphogypsum wastewater 110. The precipitated K₂SiF₆ may be removed from the salt-treated wastewater in a solids-liquid separation unit 340. The solids-liquid separation unit 340 may include or consist of a filtration unit, for example, a microfilter, a hydrocyclone, a gravity-based separation unit (for example, a clarifier), a dissolved air flotation unit, or any other form of solids-liquid separation unit known in the art. In some embodiments, the salt-treated wastewater is given sufficient residence time in the solids-liquid separation unit 340 (or in the mixing chamber 330) to allow enough time for any K₂SiF₆ that is going to precipitate to do so, or at least for the majority of the K₂SiF₆ that is going to precipitate to do so. The solids-liquid separation unit 340 separates the salt-treated wastewater into a supernatant 350 that is less saturated in Na₂SiF₆ than the raw influent phosphogypsum wastewater 110, and that may be considered pretreated wastewater, and a K₂SiF₆-containing sludge 360 that may be disposed of in, for example, a landfill. Depending on how much K₂SiF₆ was added to the phosphogypsum wastewater 110 the supernatant 350 may be saturated with K₂SiF₆.

The supernatant 350 is directed into a second mixing chamber 370 where it is diluted with raw phosphogypsum wastewater 110, optionally after the raw phosphogypsum wastewater 110 is prefiltered through prefilter 310. The amount of raw phosphogypsum wastewater 110 mixed with the supernatant 350 may be selected to achieved desired concentrations or saturation levels of K₂SiF₆ and Na₂SiF₆ in the diluted supernatant. The amount of raw phosphogypsum wastewater 110 mixed with the supernatant 350 (or rate of introduction of the raw phosphogypsum wastewater 110 into the supernatant 350) may be controlled with a valve V. Like the mixing chamber 330, the second mixing chamber 370 may be a vessel including mixing blades, aerators, or other mechanical features to facilitate mixing of the raw phosphogypsum wastewater 110 mixed with the supernatant 350 or a section of conduit through which the supernatant 350 flows and to which the raw phosphogypsum wastewater 110 is added. The section of conduit forming the second mixing chamber 370 may include a static mixer, for example, a plate-type static mixer, a helical static mixer, or other form of static mixer that induces turbulence in the raw phosphogypsum wastewater 110 and supernatant 350 mixture passing through it. The diluted pretreated wastewater exits the second mixing chamber, is optionally heated or filtered in heater or filter 380, and is directed into the first filtration unit 120 of the filtration subsystem 300b. The heater or filter 380 may include a coarse filter, for example, a screen filter or sand filter that may be utilized if prefilter 310 is not present. In some embodiments, both the prefilter 310 and the heater or filter 380 may be utilized. The diluted pretreated wastewater is treated in the filtration subsystem 300b in a manner such as described above with reference to system 100.

The system 300 include one or more sensors S positioned upstream or downstream of any one or more of the unit operations of the system 300. The one more sensors S are constructed and arranged to measure one or more parameters of the wastewater undergoing treatment in the system, of wastewater influent to the system, or of treated water exiting the system. Sensors S are illustrated in FIG. 2 connected to the conduit through which the raw phosphogypsum wastewater 110 enters the pretreatment subsystem 300a, between the solids-liquid separation unit 340 and the second mixing chamber 370, between the first filtration unit 120 and inlet for the pH adjustment agent, and on the conduit for the third effluent 200, but it is to be appreciated that additional or alternative locations for the sensors may be selected within or coupled to any conduit or vessel in the system 300.

The one or more sensors may include, for example, flow meters, water level sensors, conductivity meters, resistivity meters, chemical concentration meters, turbidity monitors, chemical species specific concentration sensors, temperature sensors, pH sensors, oxidation-reduction potential (ORP) sensors, pressure sensors, or any other sensor, probe, or scientific instrument useful for providing an indication of a desired characteristic or parameter of the wastewater undergoing treatment at any location in the system 300, of wastewater influent to the system, or of treated water exiting the system. The sensor S disposed between the first filtration unit 120 and inlet for the pH adjustment agent or on the conduit for the third effluent 200 may, for example, be a pH sensor used to provide pH measurements of the first effluent or third effluent to be used to determine an amount of pH adjustment agent to add to the first effluent. The sensor S disposed on the conduit for the third effluent 200 may, for example, be a conductivity sensor constructed and arranged to measure the electrical conductivity of the third effluent to provide a measurement used to determine if the third effluent 200 is meeting requirements for discharge to the environment or if it is not and one or more operating parameters of the system 300 should be adjusted.

With continued reference to FIG. 2, system 300 includes a controller 400 generally constructed and arranged to control operation of the system 300. In some embodiments, the controller 400 is configured to receive measurements from any or all of the sensors S. The controller 400 is in communication with one or more unit operations of the system, for example, any one or more of the source of potassium-based salt 320, source of antiscalant 160, source of pH adjustment agent 230, solid-liquid separator 340, valve V, any of the filtration units, or any other component or unit operation of the system 300. Communication lines between the sensors S and controller 400 and between the controller 400 and system components are not illustrated for the sake of clarity. Further it is to be understood that the system 300 would typically include multiple pumps, valves, flow regulators, etc. in communication with the controller 400 to control the flow rates of any fluids through any portions of the system 300. These pumps, valves, flow regulators, etc. are also omitted from the figures for the sake of clarity.

In some embodiments, the output from any one or more of the sensors S is transmitted to the controller 400 and is used by the controller 400 to determine whether to adjust one or more unit operations or components of the system, for example, to achieve desired concentrations, saturation levels, or ratio of K₂SiF₆ to Na₂SiF₆ in the supernatant 350, flow rate of wastewater or effluent into or out of any unit operation, one or more quality indicators, for example, conductivity or pH of the third supernatant 200, or any other property of wastewater undergoing treatment in any portion of the system 300.

The controller 400 may be implemented using one or more computer systems. The computer system may be, for example, a general-purpose computer such as those based on an Intel CORE®-type processor, an Intel XEON®-type processor, an Intel CELERON®-type processor, an AMD FX-type processor, an AMD RYZEN®-type processor, an AMD EPYC®-type processor, and AMD R-series or G-series processor, or any other type of processor or combinations thereof. Alternatively, the computer system may include programmable logic controllers (PLCs), specially programmed, special-purpose hardware, for example, an application-specific integrated circuit (ASIC) or controllers intended for analytical systems. In some embodiments, the controller 400 may be operably connected to or connectable to a user interface constructed and arranged to permit a user or operator to view relevant operational parameters of the system 300, adjust said operational parameters, and/or stop operation of the system 300 as needed. The user interface may include a graphical user interface (GUI) that includes a display configured to be interacted with by a user or service provider and output status information of the system 300.

The controller 400 can include one or more processors typically connected to one or more memory devices, which can comprise, for example, any one or more of a disk drive memory, a flash memory device, a RAM memory device, or other device for storing data. The one or more memory devices can be used for storing programs and data during operation of the system 300. For example, the memory device may be used for storing historical data relating to the parameters over a period. Software, including programming code that implements embodiments of the invention, can be stored on a computer readable and/or writeable nonvolatile recording medium, and then typically copied into the one or more memory devices wherein it can then be executed by the one or more processors. Such programming code may be written in any of a plurality of programming languages, for example, ladder logic, Python, Java, Swift, Rust, C, C#, or C++, G, Eiffel, VBA, or any of a variety of combinations thereof.

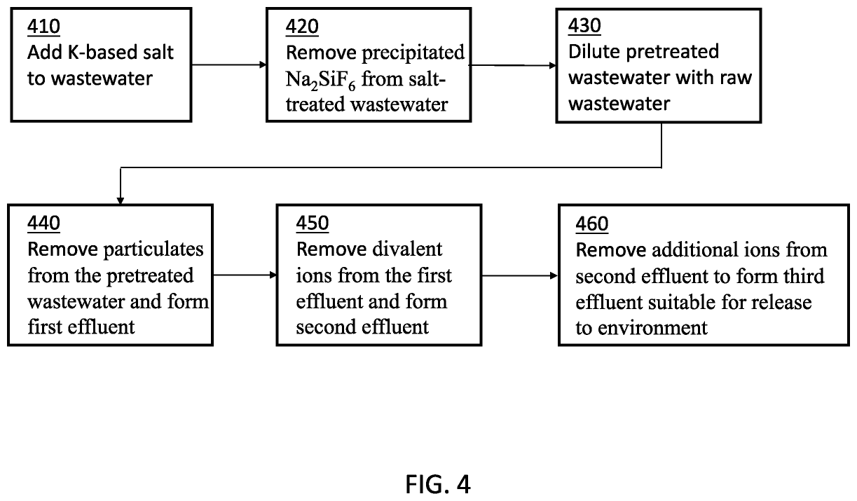

A method of treating phosphate-containing wastewater in a system such as system 300 is illustrated at a high level in the flowchart of FIG. 4. In a first act 410 a potassium-based salt is added to the wastewater to cause precipitation of sodium hexafluorosilicate Na₂SiF₆ from the wastewater. In a second act 420 precipitated Na₂SiF₆ is separated from the salt-treated wastewater to form a pretreated wastewater and a Na₂SiF₆ sludge. In a third act 430 the pretreated wastewater is diluted with raw wastewater to obtain desired concentrations of K₂SiF₆ and Na₂SiF₆ in the diluted wastewater. In a fourth act 440 particles are removed from the pretreated wastewater in a first filtration unit, for example, an ultrafilter to form a first effluent. In a fifth act 450 divalent ions are removed from the first effluent, for example, in a nanofilter to form a second effluent. In a sixth act 460 additional ions and dissolved solids are removed from the second effluent, for example, in a two-stage reverse osmosis unit to form a third effluent that has sufficiently high quality metrics to be released to the environment. Reject from the second of the reverse osmosis units in the two-stage reverse osmosis unit may be recycled to a first of the reverse osmosis units in the two-stage reverse osmosis unit upstream of the second of the reverse osmosis units. Reject from the first of the reverse osmosis units may be recycled to the nanofilter. The overall process recovery of the method may be 20% or higher.

### Example: Removal of SiF₆ from Wastewater by Dosing with KCl

Testing was performed to determine the amount of SiF₆ that could be precipitated from synthetic phosphogypsum pond wastewater by the addition of various amounts of KCl.

An example of phosphogypsum pond wastewater from one site was analyzed and found to contain the contaminants in Table 3 below:

TABLE 3

| | | |
|---|---|---|
| Calcium | mg/l as CaCO3 | 3.233 |
| Magnesium | mg/l as CaCO3 | 1.333 |
| Sodium | mg/l as CaCO3 | 5.451 |
| Potassium | mg/l as CaCO3 | 442 |
| Iron | mg/l | 150 |
| Manganese | mg/l | 23 |
| Aluminum | mg/l | 141 |
| Barium | mg/l | 0 |
| Strontium | mg/l | 42 |
| Copper | mg/l | 0 |
| Zinc | mg/l | 15 |
| Bicarbonate | mg/l as CaCO3 | 0 |
| Fluoride | mg/l as CaCO3 | 18.650 |
| Chloride | mg/l as CaCO3 | 205 |
| Bromide | mg/l as CaCO3 | 2 |
| Nitrate | mg/l as CaCO3 | 31 |
| Phosphate | mg/l as CaCO3 | 42.640 |
| Sulfate | mg/l as CaCO3 | 7.709 |
| pH (lab) | | 2 |
| pH (filed) | | |
| Turbidity | NTU | 22 |
| Conductivity | uS/cm | 35.666 |
| Total Hardness | mg/l as CaCO3 | 4.668 |
| TOC | mg/l | 151 |
| Mineral Acidity | mg/l as CaCO3 | 23.920 |
| Ammonia | mg/l as CaCO3 | 4.581 |
| Total Silica | mg/l as CaCO3 | 3.386 |
| Total Acidity | mg/l as CaCO3 | 42.673 |
| TSS | mg/l | |
| F/Si | | 5.5 |

Synthetic wastewater was produced for testing that included the most significant contaminants of concern. These contaminants were present in the synthetic wastewater in the quantities indicated in Table 4 below:

TABLE 4

Concentration

| | mol/l | g/l |
|---|---|---|
| Na | 1.244E−01 | 2.861 |
| K | 8.837E−03 | 0.346 |
| SO4 | 7.881E−02 | 7.378 |
| F | 3.733E−01 | 7.092 |
| PO4 | 2.857E−01 | 27.135 |
| Si | 6.752E−02 | 4.057 |

The synthetic wastewater was prepared in accordance with the flowing procedure:
Synthetic water stock solution (2 L) using selected chemicals to achieve the target water matrix was prepared (original pH: 1)
Due to poor dissolution nature of Na₂SiF₆ in water at room temperature, the prepared solution was stirred using magnetic stirring technique for 4 days continuously at slightly above room temperature
After extended mixing time was over, stock solution was filtered using 0.45 μm filter applying vacuum filtration
   This step ensured that only the dissolved concentration of Na₂SiF₆ was used and measured for the experiments
Selected KCl amounts (corresponding to target dosage) was added to 200 mL of the filtered synthetic solution in separate glass beakers.
The reaction was carried out for 30 mins using magnetic stirring technique at room temperature
   2 contact times were originally tested, but no significant difference in SiF₆ removal (%) was observed.
Once reaction time was complete, the samples were filtered using 0.45 μm filter applying vacuum filtration
100 mL of the treated solution was separated out for K and Na external lab analysis
For leftover 100 mL:
   The pH was measured and raised up to 10 using 50% w/w NaOH
   The pH was raised to separate F⁻ from fluorosilicate species
   After pH raise, the solutions were filtered using 0.45 μm filter applying vacuum filtration

Various amounts of KCl were added to samples of the synthetic wastewater to determine how much SiF₆ could be precipitated. The SiF₆ removal amounts were determined in accordance with the following procedure:
The untreated and treated filtrate samples of synthetic water were measured for F⁻ ions using in-house IC.
Once F concentrations were obtained, SiF₆ concentrations were calculated using F/Si ratio equal to 6
K and Na concentration results were obtained using ICP/MS analysis conducted by an external lab

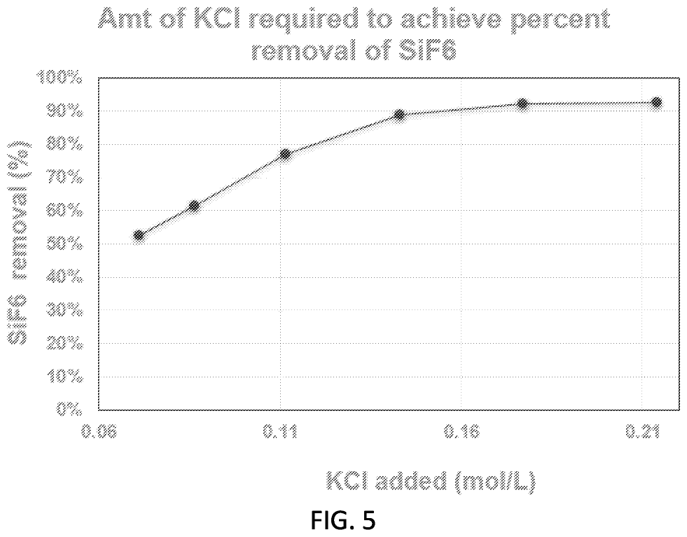

Theoretical and actual amounts of SiF₆ precipitated at various KCl dosages are tabulated in Table 5 below and charted in FIG. 5.

TABLE 5

| KCl dosage | Theoretical/target | Experimental |
|---|---|---|
| (mol/L) | SiF6 removal (%) | SiF6 removal (%) |
| 0.071 | 40.00 | 52.37% |
| 0.086 | 50.00 | 61.48% |
| 0.112 | 65.00 | 76.75% |
| 0.143 | 80.00 | 88.74% |
| 0.177 | 90.00 | 91.94% |
| 0.214 | 95.00 | 92.43% |

As can be observed, dosing of the synthetic wastewater with KCl is effective at causing precipitation of SiF₆ from the synthetic wastewater with more than 90% of the SiF₆ being able to be removed by appropriate selection of KCl dosage.

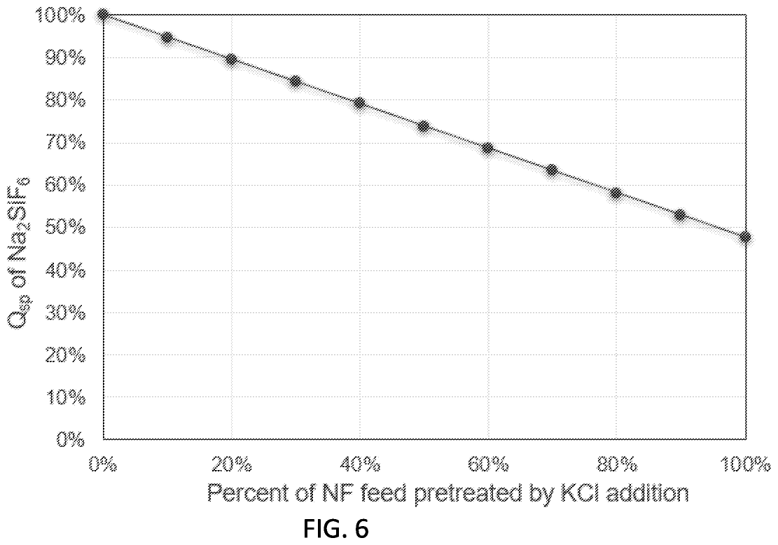

Calculations were performed to determine the scaling potential, for example, on the membrane of a nanofilter as in systems disclosed herein, of Na₂SiF₆ in KCl-treated synthetic wastewater after precipitation of 52.4% of the SiF₆ and mixing of the KCl-treated synthetic wastewater with various amounts of untreated synthetic wastewater. The solubility product quotient (Qₛₚ) of Na₂SiF₆ in the different mixtures was calculated and used as a proxy for the scaling potential of the Na₂SiF₆ in the mixtures. A chart of Qₛₚ of Na₂SiF₆ in the synthetic wastewater/KCl-treated synthetic wastewater mixtures as a function of amount of KCl-treated synthetic wastewater in the mixtures is illustrated in FIG. 6. As can be observed form FIG. 6 as the % of pretreated synthetic wastewater (using KCl precipitation) blended with the untreated synthetic wastewater increases, Qₛₚ of Na₂SiF₆ decreases, thus indicating reduced risk of scaling of a filtration membrane by the Na₂SiF₆. These results indicate that in the treatment of phosphogypsum pond wastewater in systems as disclosed herein, blending the potassium salt-treated solution with untreated pond water results in a solution that is expected to be under saturation with regard to both K₂SiF₆ and Na₂SiF₆. The blend can then be concentrated in the NF step of a system as disclosed herein with a recovery higher than 20%.

The phraseology and terminology used herein is for the purpose of description and should not be regarded as limiting. As used herein, the term “plurality” refers to two or more items or components. The terms “comprising.” “including.” “carrying,” “having,” “containing.” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Having thus described several aspects of at least one embodiment, it is to be appreciated various alterations, modifications, and improvements will readily occur to those skilled in the art. Any feature described in any embodiment may be included in or substituted for any feature of any other embodiment. Such alterations, modifications, and improvements are intended to be part of this disclosure and are intended to be within the scope of the invention. Accordingly, the foregoing description and drawings are by way of example only.

Those skilled in the art should appreciate that the parameters and configurations described herein are exemplary and that actual parameters and/or configurations will depend on the specific application in which the disclosed methods and materials are used. Those skilled in the art should also recognize or be able to ascertain, using no more than routine experimentation, equivalents to the specific embodiments disclosed.

1. A water treatment system, the system comprising:
a pretreatment subsystem including:
a first stream comprising dissolved potassium species;
a mixing chamber configured to mix the first stream with a second stream, the second stream comprising hexafluorosilicate, the mixing chamber comprising an outlet for a third stream, the third stream comprising potassium hexafluorosilicate (K₂SiF₆); and
a solids-liquid separator fluidly connected to the outlet of the mixing chamber, the solids-liquid separator configured to separate K₂SiF₆ as a precipitate from the third stream and produce a pretreated stream; and
a filtration subsystem fluidly connected downstream of the pretreatment subsystem.

2. The system of claim 1, wherein the filtration subsystem comprises:
a first filtration unit having an inlet fluidly connected to an outlet of the pretreatment subsystem and configured to receive the pretreated stream, the first filtration unit configured to separate the pretreated stream into a first effluent stream and a first reject stream, the first effluent stream having a lesser particulate concentration than the pretreated stream;
a second filtration unit downstream of the first filtration unit and configured to receive the first effluent stream and separate the first effluent stream into a second effluent stream and a second reject stream, the second effluent stream having a lower concentration of multivalent ions than the first effluent stream; and
a third filtration unit downstream of the second filtration unit and configured to receive the second effluent stream and filter the second effluent stream to form a third effluent stream having a concentration of dissolved solids lower than a concentration of dissolved solids in the second effluent stream.

3. The system of claim 2, further comprising a conduit configured to return the first reject stream to a source of the first stream.

4. The system of claim 2, further comprising a conduit configured to return the second reject stream to a source of the first stream.

5. The system of claim 2, further comprising a source of pH adjustment agent configured to dose the first effluent stream with the pH adjustment agent.

6. The system of claim 2, further comprising a source of antiscalant configured to dose the first effluent stream with the antiscalant.

7. The system of claim 2, wherein the third filtration unit includes one or more reverse osmosis units.

8. The system of claim 7, wherein the one or more reverse osmosis units includes a first reverse osmosis unit configured to separate the second effluent stream into a first permeate stream and a first retentate stream.

9. The system of claim 8, wherein the second filtration unit includes a nanofilter.

10. The system of claim 9, further comprising a conduit configured to direct the first retentate stream into an inlet of the nanofilter or to a source of the first stream.

11. The system of claim 8, wherein the one or more reverse osmosis units further includes a second reverse osmosis unit configured to separate the first permeate stream into a second permeate stream and a second retentate stream.

12. The system of claim 11, wherein the second permeate stream is the third effluent stream.

13. The system of claim 11, further comprising a conduit configured to direct the second retentate stream into an inlet of the first reverse osmosis unit along with the first permeate stream.

14. The system of claim 2, wherein the first filtration unit includes an ultrafilter.

15. The system of claim 1, wherein the first stream comprises KCl at a concentration in a range of from 0.07 mol/L to 0.2 mol/L.

16. The system of claim 1, further comprising a second mixing chamber configured to dilute the pretreated stream with wastewater from a source of wastewater to produce a diluted pretreated stream.

17. The system of claim 16, further comprising a particle filter disposed in fluid communication between the source of wastewater and an inlet of the second mixing chamber.

18. The system of claim 16, wherein the first stream includes sodium hexafluorosilicate (Na₂SiF₆) and the system further comprises a controller configured to regulate dilution of the pretreated stream with the wastewater to render substantially equal saturation levels of Na₂SiF₆ and K₂SiF₆ in the diluted pretreated stream.

19. The system of claim 16, wherein the first stream includes sodium hexafluorosilicate (Na₂SiF₆) and the system further comprises a controller configured to regulate dilution of the pretreated stream with the wastewater to render the diluted pretreated stream with concentrations of K₂SiF₆ and Na₂SiF₆ having substantially equal potentials for depositing scale in the second filtration unit.

20. The system of claim 1, further comprising one or more particle filters fluidically disposed at least one of upstream of the pretreatment subsystem or between the pretreatment subsystem and the filtration subsystem.

21.-36. (canceled)
